(19) United States
(12) Patent Application Publication
(10) Pub. No.: US 2008/0291681 A1
(43) Pub. Date: Nov. 27, 2008

(54) Inflatable portable lamp

(76) Inventor: Thomas Appleton, Whitby (CA)

Correspondence Address: Muncy, Geissler, Olds & Lowe, PLLC, P.O. BOX 1364, FAIRFAX, VA, 22038-1364, US

(21) Appl. No.: 12/153,773

(22) Filed: May 23, 2008

(30) Foreign Application Priority Data
May 25, 2007 (CA) 2,590,070

(51) Int. Cl. F21V 7/04; F21V 7/00

(52) U.S. Cl. 362/307; 362/247

(57) ABSTRACT

The lamp includes an inflatable balloon-like enclosure composed of translucent or transparent material. When the lamp is not in use, the enclosure may be deflated and stowed within a receptacle which serves as a base for the lamp. The lamp is illuminated by a strip of one or more rings of light emitting diodes suspended within the enclosure. Alternatively. The lamp may be illuminated by incandescent or fluorescent bulbs or white or black halide lights suspended within the enclosure.

### FIELD OF THE INVENTION

This invention relates to portable lamps and more particularly to a inflatable lamp which inflates for use as a source of illumination and deflates for storage or transport.

### BACKGROUND OF THE INVENTION

Special events staged in the evenings in the out-of-doors are conventionally illuminated by spotlights mounted on tripods. Such spotlights are also used for illuminating a construction site where work is carried on around the clock and where the location of work is changing. Spotlights mounted on tripods are particularly useful for this purpose because they are portable and because they are capable of giving off a great deal of light.

Spotlights have, however, a number of shortcomings. They are relatively heavy and are usually so large that a trailer is required to transport them. Another shortcoming is that spotlights direct all their illumination in one direction. The illumination is frequently so bright that it is blinding to persons who face the spotlights.

I have invented an inflatable lamp which obviates many of the shortcomings of conventional spotlights. My lamp has an illuminated inflatable enclosure which is less directional than a spotlight and provides a less intense illumination over a broader area. As a result, it is not blinding to persons who face it. In addition, the enclosure, when not in use, deflates to a very compact size and fits into a rectangular-sided receptacle. The receptacle can be carried by one or two persons and is small enough to fit into a compact car.

A further advantage of my lamp is that it is easy to assemble. Once the receptacle in which the inflatable enclosure is stowed is placed in position, the enclosure is prepared for use simply by connecting the lamp to an electrical outlet and inflating the enclosure by means of a blows located within the receptacle. When the enclosure is fully inflated, it is braced by means of guys or other meals to prevent it from moving excessively in a wind. There are no heavy parts to lift unlike a conventional spotlight.

### SUMMARY OF THE INVENTION

Briefly the inflatable lamp of my invention includes a receptacle and an inflatable enclosure which is composed of translucent or transparent material. When the enclosure is deflated, it is adapted to be stowed in the receptacle and when it is inflated it extends upwardly from the receptacle. The lamp also includes a source of illumination, disposed within the enclosure and means for causing the column to inflate.

### DESCRIPTION OF THE DRAWINGS

The inflatable lamp of the invention is described with reference to the accompanying drawings in which:

FIG. 1 is a perspective view of a first embodiment of the lamp;

FIG. 2 is an elevation of the lamp showing the interior of the receptacle;

FIG. 3 is an elevation of a second embodiment of the lamp; and

FIG. 4 is an elevation of a third embodiment of the lamp.

Like reference characters refer to like parts throughout the description of the drawings.

### DESCRIPTION OF PREFERRED EMBODIMENTS

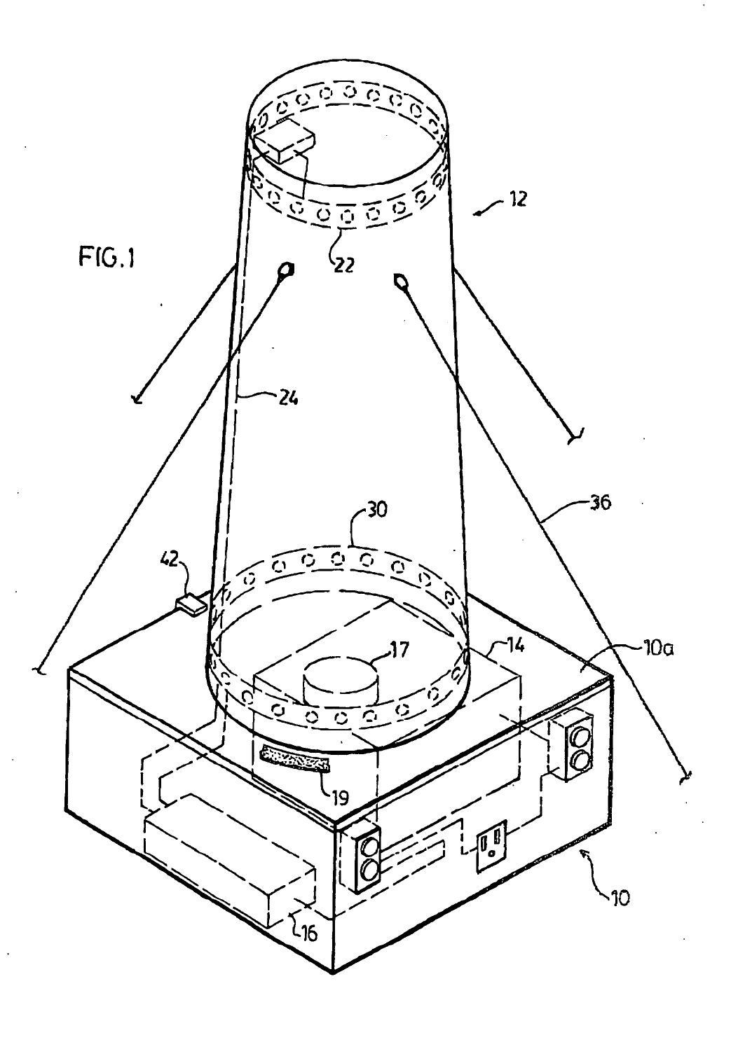

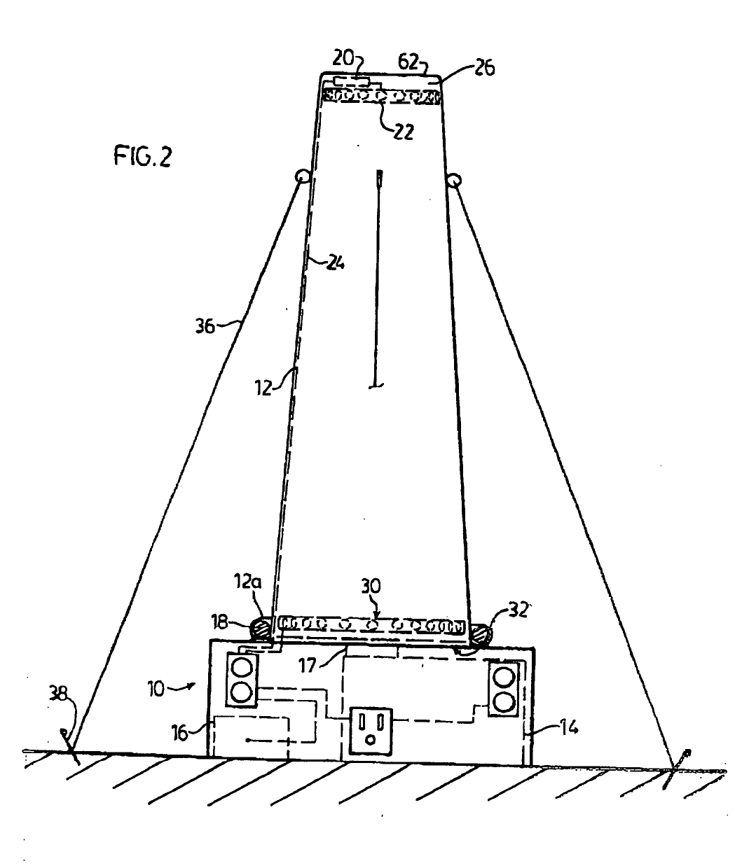

With reference to FIGS. 1 and 2, the lamp of the invention includes a receptacle, generally 10, and an inflatable enclosure, generally 12 disposed above the receptacle. Mounted within the receptacle is a blower 14 and a ballast 16 for stabilizing the current in the electrical circuit which extends through the lamp.

Blower 14 is conventional and functions to draw air from outside the receptacle and to drive it under pressure through a duct 17 to an opening in the upper wall of the receptacle.

The inflatable enclosure is preferably composed of rip stop nylon coated by a layer of polyurethane. Other flexible strong polymeric material, preferably coated with a fire resistant coating, is suitable as long as it is either translucent or transparent.

The inflatable enclosure is airtight except for an opening in its lower wall which communicates with duct 17 and a vent in its upper wall described below. Air from the blower is driven under pressure through duct 17 and into the interior of the inflatable enclosure. A conventional seal prevents the air from the duct from escaping to the atmosphere.

Velcro is used to removably attach the enclosure to the receptacle. In this regard, a ring 18 is attached by loops 12a which are stitched to the lower end of the enclosure. Surrounding the ring is a strip of looped fabric of Velcro, generally 19. The complementary burred fabric of Velcro is attached to the lid 10a of the receptacle.

A vent 22 in the upper wall of the inflatable enclosure allows hot air within the interior to escape.

Before air is introduced into the interior of the inflatable enclosure, the enclosure is substantially flat and may be stowed in the receptacle. When air from the blower is introduced into the interior of the inflatable enclosure, the enclosure inflates to a generally frusto-conical configuration as illustrated in the Figures.

Mounted within the upper portion of the inflatable enclosure is a ring 22 along which a number light-emitting diodes (LEDs) is mounted. The ring is connected to the interior wall of the inflatable enclosure by conventional means such as by Velcro or other adhesive material. An electric wire 24 extends from ballast 16 upwardly along the interior wall of the inflatable enclosure to the LEDs.

Above the ring of LEDs is a band 26 of conventional reflective material for reflecting light emitted from the LEDs downward into the interior of the inflatable enclosure.

A second ring 30 of LEDs is attached to the interior wall of the inflatable enclosure adjacent to its lower wall and it too is electrically connected to ballast 16. A band 32 of reflective material is mounted beneath ring 30 for reflecting light emitted from the LEDs upward into the interior of the inflatable enclosure.

Thee or four guy wires 36 extend from the upper portion of the inflatable enclosure to pegs 38 in the ground for anchoring the inflatable enclosure and stabilizing the lamp against excessive movement should the lamp be exposed to a wind where it is located.

A latch 42 is provided for fastening the lid. When the inflatable enclosure is not it use it folds flat within the receptacle. The LEDs, reflectors as well as the blower and ballast are all accommodated within the receptacle where they are protected from rain and snow should the receptacle be out-of-doors.

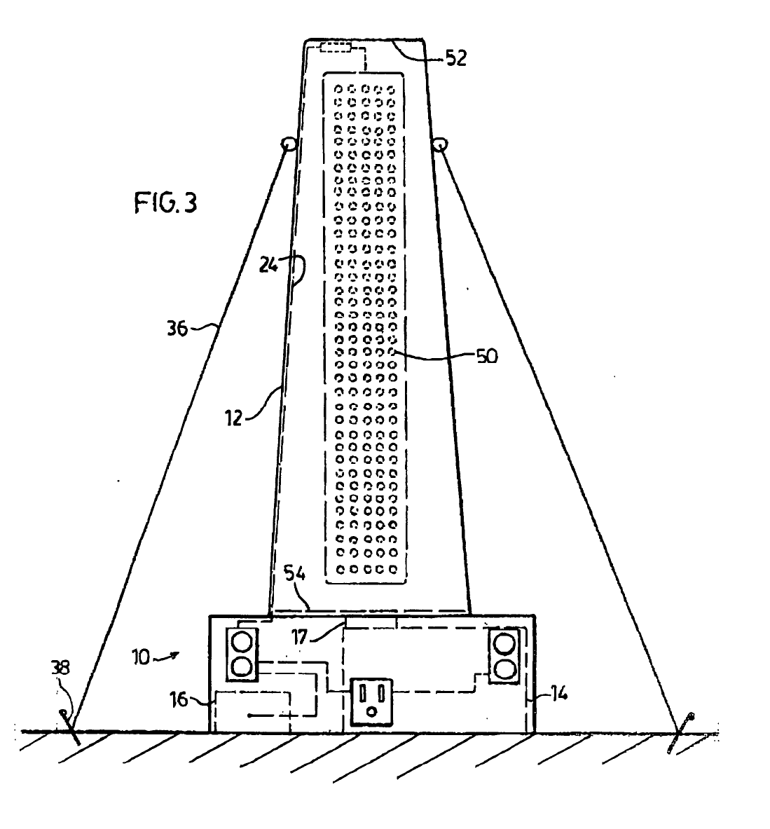

With reference to FIG. 3, the lamp is the same as that illustrated in FIG. 1 except that a strip of flexible material 50 is substituted for rings 22, 30 of FIG. 1. The strip extends upwardly from slightly above the receptacle to just short of the upper wall of the inflatable enclosure. LEDs are attached to the entire front face of the strip.

Upper and lower bands 52, 54 of reflective material are attached to or are adjacent to the upper and lower walls, respectively, of the inflatable enclosure.

In FIG. 3, the LED's are all attached to the front face of the strip and illuminate one side of the lamp. Additional LEDs may be attached to the back face of the strip for illumination of the rear of the lamp.

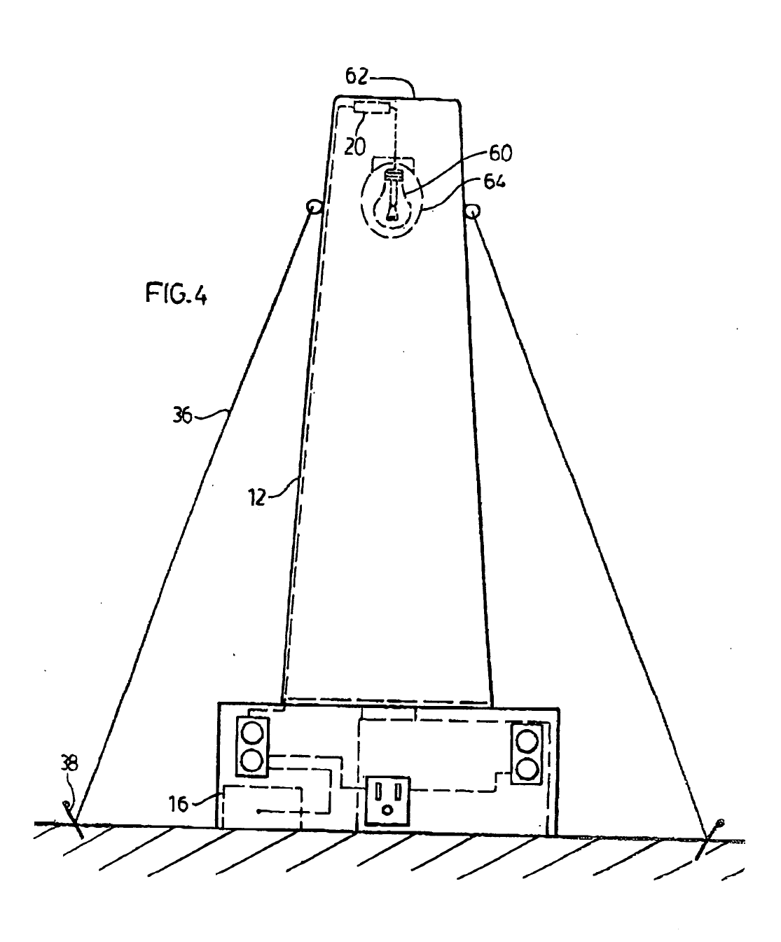

With reference to FIG. 4, a conventional light bulb 60 is substituted for the rings or strips of LEDs illustrated in FIGS. 1-3. The bulb is located adjacent to the upper wall 62 of the inflatable enclosure and is mounted within a light-weight metallic cage 64 to protect it in the event that the enclosure is accidentally struck while it is being inflated or while the lamp is in use and the enclosure is fully inflated.

The light bulb of FIG. 4 can be incandescent, high energy or white or black halide lights. White light is preferred for illuminating large areas for maximum visibility while a black light is preferred for special events, bars, dances and so on. Both black and white lights are suitable for promotional or advertising events.

The size and shape of the inflatable enclosure can be altered and customized to suit the particular application. For example, the inflatable enclosure can be columnar or fully conical.

It will be understood, of course that modifications can be made in the structure of the lamp of tie invention as described herein without departing from the scope and purview of the invention as defined in the appended claims.

I claim:

1. A inflatable lamp including a receptacle; an inflatable enclosure which is composed of translucent or transparent material and which, when deflated, is adapted to be stowed in said receptacle and which, when inflated, extends upwardly from said receptacle; a source of illumination disposed within said enclosure; and means for causing said column to inflate.

2. The lamp of claim 1 wherein said inflatable enclosure is composed of rip stop nylon coated by a layer of polyurethane

3. The lamp of claim 1 wherein said source of illumination is a plurality of light emitting diodes.

4. The lamp of claim 4 further including a ring suspended within said enclosure, said light emitting diodes being mounted to said ring.

5. The lamp of claim 4 wherein said enclosure has spaced apart upper and lower walls, said lamp further including a pair of rings suspended within said enclosure, said light emitting diodes being mounted to said ring, one said ring being disposed adjacent to said upper wall and the other said ring being mounted adjacent to said lower wall.

6. The lamp of claim 3 further including a strip of flexible material which is oriented vertically within said enclosure, said light emitting diodes being attached to said strip.

7. The lamp of claim 6 wherein said enclosure has spaced apart upper and lower walls and wherein said strip has oppositely facing front and back faces, said strip extending upwardly from slightly above said lower wall to slightly below said upper wall and said light emitting diodes cover substantially the entire front face of said strip.

8. The lamp of claim 7 wherein said light emitting diodes cover substantially both, the entire front and back faces of said strip.

9. The lamp of claim 1 wherein said source of illumination is an electric light bulb mounted adjacent to said upper wall.

10. The lamp of claim 1 wherein said source of illumination is white or black halide light.

11. The lamp of claim 3 wherein said enclosure has spaced apart upper and lower walls, said lamp further having an upper light-reflector disposed within said inflatable enclosure and adjacent to said upper wall, said reflector being disposed above said source of illumination and positioned to reflect light downward.

12. The lamp of claim 3 wherein said enclosure has spaced apart upper and lower walls, said lamp further having a lower light-reflector disposed within said inflatable enclosure and adjacent to said lower wall, said reflector being mounted to reflect light upward.

13. The lamp of claim 3 wherein said enclosure has spaced apart upper and lower walls, said lamp further having upper and lower light-reflectors mounted to reflect light downward and upward respectively, said upper reflector being disposed adjacent to said upper wall and above said source of illumination, said lower reflector being disposed adjacent to said lower wall.

14. The lamp of claim 1 wherein said inflating means is a blower disposed within said receptacle.

15. The lamp of claim 1 wherein said inflatable enclosure is columnar.

16. The lamp of claim 1 wherein said inflatable enclosure is frusto-conical.
